(19) United States
(12) Patent Application Publication
(10) Pub. No.: US 2015/0211533 A1
(43) Pub. Date: Jul. 30, 2015

(54) ELECTRIC COMPRESSOR

(71) Applicant: KABUSHIKI KAISHA TOYOTA JIDOSHOKKI, Kariya-shi (JP)

(72) Inventor: Yoshiki NAGATA, Kariya-shi (JP)

(73) Assignee: KABUSHIKI KAISHA TOYOTA JIDOSHOKKI, Kariya-shi (JP)

(21) Appl. No.: 14/605,573

(22) Filed: Jan. 26, 2015

(30) Foreign Application Priority Data
Jan. 27, 2014 (JP) 2014-012281

(51) Int. Cl. F04D 25/06; H02P 23/00

(52) U.S. Cl. CPC F04D 25/06; H02P 23/0063

(57) ABSTRACT

An electric compressor capable of appropriately starting a motor depending on a condition of a compressing unit is provided. The electric compressor includes: an AC motor including a rotor having a permanent magnet and a stator where a multi-phase coil is wound, and driving a scroll compressor; and an inverter apparatus controlling the AC motor. The inverter apparatus includes: a switching circuit supplying the AC motor with current; and a motor control unit controlling the switching circuit. The motor control unit: measures an elapsed time from a stop to a start of the AC motor for controlling the switching circuit depending on a load on the scroll compressor; calculates a target acceleration of the rotor followed when starting the AC motor, based on the measured elapsed time; and controls the switching circuit so that the rotor is started with the target acceleration.

This nonprovisional application is based on Japanese Patent Application No. 2014-012281 filed on Jan. 27, 2014 with the Japan Patent Office, the entire contents of which are hereby incorporated by reference.

### BACKGROUND OF THE INVENTION

1. Field of the Invention

The present disclosure relates to an electric compressor.

2. Description of the Background Art

In recent years, a motor in which a permanent magnet is placed in a rotor has been used widely for an air conditioner or a vehicle such as hybrid vehicle, electric vehicle, or fuel cell vehicle. As a start scheme for starting such a motor, the following technique has been proposed.

For example, Japanese Patent Laying-Open No. 2005-137069 discloses that a DC brushless motor for a compressor is started in the following way. When a start fails, start parameters for the DC brushless motor are changed to data stored in advance and restarts are successively done. When the number of times this start has failed reaches a predetermined number of times, an abnormal stop is made. Thus, in the course of successively changing a combination of the start parameters, the DC brushless motor is started.

### SUMMARY OF THE INVENTION

The technique disclosed in Japanese Patent Laying-Open No. 2005-137069, however, is a start scheme applied to the case where a start of the DC brushless motor for a compressor fails, and does not give consideration to the condition of the compressor from the time the motor is stopped to the time the motor is restarted.

An object in an aspect of the present disclosure is to provide an electric compressor capable of appropriately staring a motor depending on a condition of a compressing unit.

An electric compressor according to an embodiment includes: an AC motor including a rotor having a permanent magnet and a stator where a multi-phase coil is wound, and configured to drive a compressing unit; and an inverter apparatus configured to control the AC motor. The inverter apparatus includes: a switching circuit configured to supply the AC motor with current; and a control unit configured to control the switching circuit. The control unit is configured to: measure an elapsed time from a stop of the AC motor to a start of the AC motor for controlling the switching circuit depending on a load on the compressing unit; calculate a target acceleration of the rotor followed when starting the AC motor, based on the measured elapsed time; and control the switching circuit so that the rotor is started with the target acceleration.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit diagram showing a configuration of an electric compressor according to the present embodiment.

FIG. 2 is a diagram for illustrating a motor start control scheme performed by a motor control unit.

FIG. 3A is a conceptual diagram showing a waveform of current of one phase when an AC motor is started.

FIG. 3B is a conceptual diagram showing a waveform of current of one phase when an AC motor is started.

FIG. 4 is a flowchart showing a restart process performed by the motor control unit.

FIG. 5 is a diagram showing a relationship between an acceleration when a motor is started and a time elapsed from a normal stop to a restart.

### DESCRIPTION OF THE PREFERRED EMBODIMENTS

The following describes the present embodiment in detail with reference to figures. It should be noted that the same or corresponding portions in the figures are given the same reference characters and explanations thereof are not repeated.

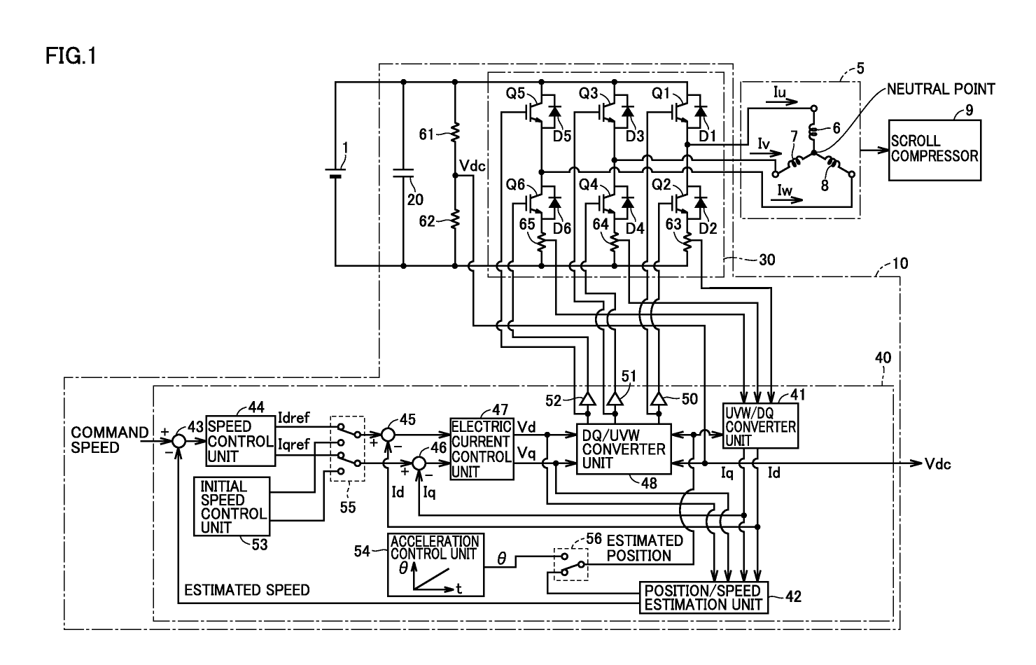

FIG. 1 is a circuit diagram showing a configuration of an electric compressor according to the present embodiment. Referring to FIG. 1, the electric compressor includes an AC motor 5, an inverter apparatus 10, a scroll compressor (compressing unit) 9 driven by the AC motor 5.

The inverter apparatus 10 receives an input of power from a high voltage battery 1 which is a DC power supply and controls driving of the AC motor 5. The AC motor 5 is a three-phase synchronous motor which includes a rotor having a permanent magnet and a stator where respective phase coils 6, 7, and 8 are wound. For example, the AC motor 5 is used as a motor for an air conditioner of a vehicle (a motor for an air conditioner compressor).

The inverter apparatus 10 includes a capacitor 20, a switching circuit 30, and a motor control unit 40.

A positive electrode terminal of the high voltage battery 1 is connected to one terminal of the capacitor 20 and a positive electrode power line of the switching circuit 30. A negative electrode terminal of the high voltage battery 1 is connected to the other terminal of the capacitor 20 and a negative electrode power line of the switching circuit 30. The switching circuit 30 is supplied with a DC power from the high voltage battery 1 via the capacitor 20. Although not shown, it should be noted that the high voltage battery 1 may be a power source supplying power to drive a motor for traveling which is included in an electric vehicle or a hybrid vehicle.

The switching circuit 30 includes switching elements Q1 to Q6, diodes D1 to D6, and shunt resistors 63 to 65. Examples of the switching elements Q1 to Q6 used herein include an IGBT (Insulated Gate Bipolar Transistor). The switching elements Q1, Q2 for U phase and the shunt resistor 63 are connected in series between the positive electrode power line and the negative electrode power line. The switching elements Q3, Q4 for V phase and the shunt resistor 64 are connected in series between the positive electrode power line and the negative electrode power line. The switching elements Q5, Q6 for W phase and the shunt resistor 65 are connected in series between the positive electrode power line and the negative electrode power line. The diodes D1 to D6 are connected in anti-parallel with the switching elements Q1 to Q6, respectively. Coils 6, 7, and 8 corresponding to respective phases of the AC motor 5 are connected to a connection node of the switching elements Q1, Q2, a connection node of the switching elements Q3, Q4, and a connection node of the switching elements Q5, Q6, respectively. The coils 6, 7, and 8 are Y-connected.

Resistors 61, 62 are connected in series between the positive electrode power line and the negative electrode power line on a power source input side of the switching circuit 30. An input voltage can be detected based on a voltage Vdc of a connection node of the resistors 61, 62. A current flowing in the AC motor 5 can be detected based on voltages of the shunt resistors 63 to 65.

The motor control unit 40 vector-controls the AC motor 5. The motor control unit 40 includes a uvw/dq converter unit 41, a position/speed estimation unit 42, a subtracter 43, a speed control unit 44, subtracters 45 and 46, an electric current control unit 47, and a dq/uvw converter unit 48.

A command speed of the AC motor 5 is input from the outside to the subtracter 43 of the motor control unit 40. The motor control unit 40 drives the switching circuit 30 by the vector control corresponding to the command speed.

The dq/uvw converter unit 48 outputs a U phase control signal, a W phase control signal, and a V phase control signal. A gate terminal of the switching element Q1 receives the U phase control signal from the dq/uvw converter unit 48. A gate terminal of the switching element Q2 receives an inverted signal of the U phase control signal output from an inverter 50.

A gate terminal of the switching element Q3 receives the V phase control signal from the dq/uvw converter unit 48. A gate terminal of the switching element Q4 receives an inverted signal of the V phase control signal output from an inverter 51.

A gate terminal of the switching element Q5 receives the W phase control signal from the dq/uvw converter unit 48. A gate terminal of the switching element Q6 receives an inverted signal of the W phase control signal output from an inverter 52.

The uvw/dq converter unit 41 calculates an excitation component current Id and a torque component current Iq by converting current values detected at the shunt resistors 63 to 65 into a d-axis coordinate and a q-axis coordinate on a rotor shaft of the AC motor 5. The calculated excitation component current Id and the calculated torque component current Iq are input to the position/speed estimation unit 42. The calculated excitation component current Id is also input to the subtracter 45. The calculated torque component current Iq is also input to the subtracter 46.

The position/speed estimation unit 42 calculates a rotor estimation speed and a rotor estimation position of the AC motor 5 based on the excitation component current Id, the torque component current Iq, an excitation component voltage Vd, and a torque component voltage Vq. The calculated rotor estimation speed is input to the subtracter 43. The calculated rotor estimation position is input to each of the uvw/dq converter unit 41 and the dq/uvw converter unit 48 via a switching unit 56.

The subtracter 43 subtracts the rotor estimation speed from the command speed. The speed control unit 44 receives a difference between the command speed and the estimated speed from the subtracter 43, and calculates a target value Idref for the excitation component current Id and a target value Iqref for the torque component current Iq. The target value Idref for the excitation component current Id is input to the subtracter 45 via a switching unit 55. The target value Iqref for the torque component current Iq is input to the subtracter 46 via the switching unit 55.

The subtracter 45 subtracts the excitation component current Id from the target value Idref. This subtraction result is input to the electric current control unit 47. The subtracter 46 also subtracts the torque component current Iq from the target value Iqref This subtraction result is input to the electric current control unit 47. The electric current control unit 47 calculates, based on the difference between the target value Idref and the excitation component current Id, the excitation component voltage Vd which is a result of conversion into a d-axis coordinate on the rotor shaft of the AC motor 5. This excitation component voltage Vd is input to the dq/uvw converter unit 48 and the position/speed estimation unit 42. The electric current control unit 47 also calculates, based on the difference between the target value Iqref and the torque component current Iq, the torque component voltage Vq which is a result of conversion into a q-axis coordinate on the rotor shaft of the AC motor 5. This torque component voltage Vq is input to the dq/uvw converter unit 48 and the position/speed estimation unit 42.

A voltage Vdc generated by voltage division by the resistors 61, 62 is input to the dq/uvw converter unit 48. The dq/uvw converter unit 48 calculates driving voltages Vu, Vv, and Vw corresponding to the respective phase coils 6, 7, and 8 of the AC motor 5 based on the rotor estimation position, the excitation component voltage Vd, the torque component voltage Vq, and the voltage Vdc which are input to the dq/uvw converter unit 48. The dq/uvw converter unit 48 generates driving waveform signals (PWM signals) required to obtain the driving voltages Vu, Vv, and Vw. Each of the switching elements Q1 to Q6 of the switching circuit 30 is driven on/off by the driving waveform signal.

Thus, in the present embodiment, the motor control unit 40 performs PWM control of the switching elements Q1 to Q6 provided in a current path of the AC motor 5 so that the excitation component current Id and the torque component current Iq in the AC motor 5 each become a target value thereof. The excitation component current and the torque component current are obtained from the current detected at the shunt resistors 63 to 65.

The motor control unit 40 performs control for an initial driving operation until a rotational speed of the rotor reaches a predetermined speed or more. The motor control unit 40 performs control for a sensorless operation after the rotational speed of the rotor reaches the predetermined speed or more. The sensorless operation is an operation for rotating the motor based on each of estimation values of the rotor position and the rotor rotational speed. Each of the estimation values is estimated from motor current and the like, without a rotational speed sensor such as a resolver and the like detecting a rotor position of a motor. In the control for the sensorless operation, a closed-loop speed control is performed with the position/speed estimation unit 42 and the speed control unit 44.

In the following, a description will be further given of a configuration for the initial driving operation.

The motor control unit 40 includes an initial speed control unit 53, the switching unit 55, an acceleration control unit 54, and the switching unit 56. The initial speed control unit 53 is configured to output a speed command at the time of initial driving. The switching unit 55 is configured to switch to output to subtracters 45, 46 one of an output from the initial speed control unit 53 and an output from the speed control unit 44. The acceleration control unit 54 is configured to perform an acceleration control at the time of initial driving. The switching unit 56 is configured to switch to output to uvw/dq converter unit 41 and the dq/uvw converter unit 48 one of an output from the acceleration control unit 54 and an estimated position output from the position/speed estimation unit 42. It should be noted that the initial speed control unit 53 changes the speed command at the time of initial driving depending on an acceleration until the rotational speed of the rotor reaches a desired speed.

At the time of the initial driving operation, an open-loop control is performed, in terms of speed, with the initial speed control unit 53 and the acceleration control unit 54, instead of a closed-loop speed control performed with the position/speed estimation unit 42 and the speed control unit 44.

According to the above-mentioned configuration, the switching elements Q1 to Q6 of the switching circuit 30 are controlled based on the command speed, and a DC current is converted into three-phase AC currents. The three-phase AC currents generated by conversion by the switching circuit 30 are supplied to the respective phase coils 6, 7, and 8 in the AC motor 5. The AC motor 5 for the air conditioner is driven by these three-phase AC currents.

It should be noted that the switching circuit 30 is connected to the high voltage battery (DC power supply) 1 in FIG. 1. Alternatively, an AC voltage of an AC power supply may be converted into a DC voltage and the DC voltage may be supplied to the switching circuit 30.

The shunt resistors 63 to 65 are used for current detection units. Alternatively, a hall element for detecting three-phase AC currents may be provided between the switching circuit 30 and the AC motor 5 instead of the shunt resistor.

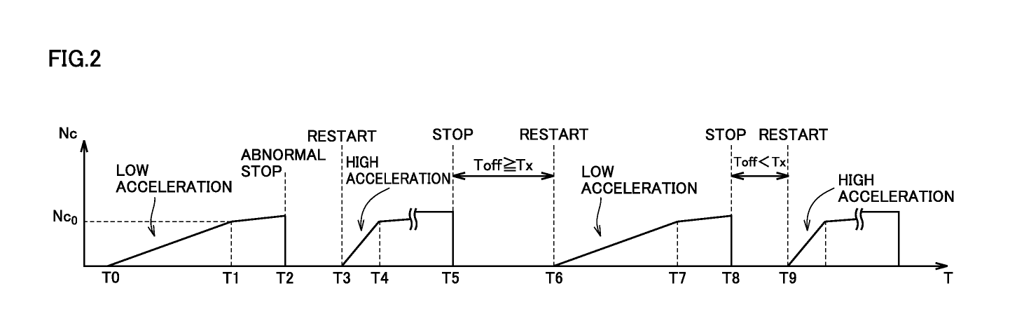

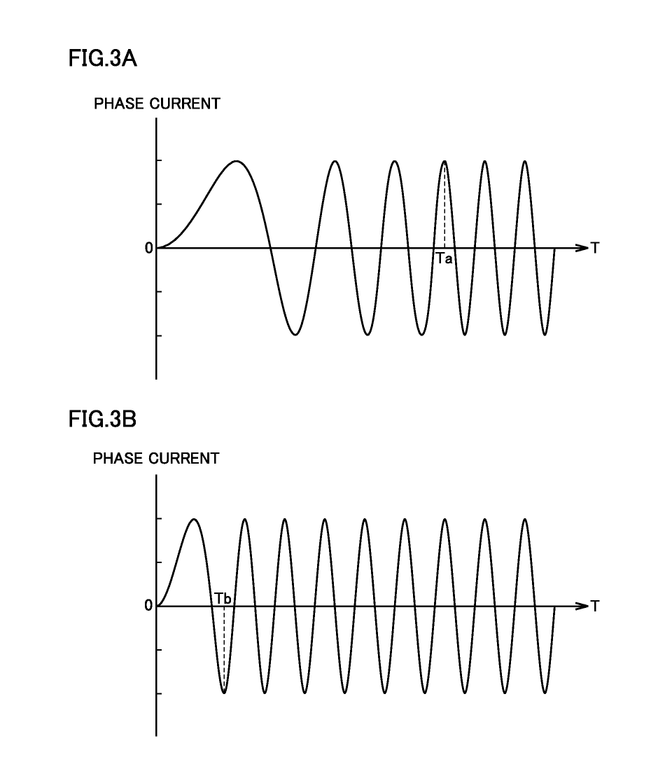

FIG. 2 is a diagram for illustrating a motor start control scheme performed by the motor control unit 40. In FIG. 2, the horizontal axis represents time T and the vertical axis represents a rotational speed Nc of the rotor. FIGS. 3A and 3B are a conceptual diagram showing a waveform of current of one phase when the AC motor 5 is started. More specifically, FIG. 3A shows a current waveform in the case where the AC motor 5 is started while being accelerated with a low acceleration, and FIG. 3B shows a current waveform in the case where the motor is started while being accelerated with a high acceleration. In the following, the motor start control scheme will be described with reference to FIGS. 2, 3A and 3B.

Referring to FIG. 2, the motor control unit 40 begins starting the AC motor 5 at time T0. Then, at the time of initial driving, the motor control unit 40 performs an acceleration control (low acceleration control) for rotating the rotor with a low acceleration. Specifically, the motor control unit 40 starts energizing the switching circuit 30 and increases an output frequency little by little until the output frequency reaches a predetermined frequency. Referring to FIG. 3A, it is seen that a relatively long time Ta is elapsed for the output frequency to reach a predetermined frequency. For example, the acceleration for the low acceleration control is an acceleration that is enough to provide a low possibility of a failure to start, in the case where the AC motor 5 is started from an initial state in which the load on the AC motor 5 is small. In the case where the low acceleration control is performed, the motor makes a relatively quiet sound when started. It should be noted that the process of increasing the output frequency is performed by the acceleration control unit 54 in the configuration shown in FIG. 1.

The motor control unit 40 performs the acceleration control for rotating the rotor with the low acceleration. When the rotational speed of the rotor reaches a rotational speed Nc₀ (namely the output frequency reaches the predetermined frequency) (time T1), the motor control unit 40 shifts to a sensorless control while gradually increasing the rotational speed.

In the case where the AC motor 5 makes an abnormal stop (time T2) due to loss of synchronism or occurrence of overcurrent and thereafter the AC motor 5 is restarted (time T3), it is assumed that a load on the AC motor 5 is high when the motor is started, and therefore, the motor control unit 40 performs an acceleration control (high acceleration control) for rotating the rotor with a high acceleration which is higher than the above-referenced low acceleration, in order to avoid a failure to start. Specifically, the motor control unit 40 starts energizing the switching circuit 30 and increases the output frequency at a higher rate than that under the low acceleration control, until the output frequency reaches a predetermined frequency. Referring to FIG. 3B, it is seen that a time Tb is elapsed for the output frequency to reach a predetermined frequency, namely it takes a shorter time to reach the predetermined frequency, as compared with the low acceleration control. “High acceleration” is, for example, an acceleration of approximately ten times as high as the aforementioned low acceleration.

It should be noted that the motor control unit 40 determines, based on a predetermined condition, whether the AC motor 5 has made an abnormal stop (the AC motor 5 has made a stop without a stop command) or a normal stop (the AC motor 5 has made a stop, rather than an abnormal stop, in accordance with a normal stop command). Specifically, in the case where an abnormality such as loss of synchronism occurs, the AC motor 5 is stopped in spite of the fact that driving waveform signals (PWM signals) are output. Therefore, the motor control unit 40 detects the number of revolutions of the AC motor 5 and determines that the stop of the AC motor 5 is an abnormal stop, based on the detected number of revolutions. In another case where overcurrent occurs in the AC motor 5 which is found based on current values detected at the shunt resistors 63 to 65 when the AC motor 5 makes a stop, the motor control unit 40 determines that the stop of the AC motor 5 is an abnormal stop.

Subsequently, the motor control unit 40 performs an acceleration control for rotating the rotor with a high acceleration. When the rotational speed of the rotor reaches the rotational speed Nc₀ (time T4), the motor control unit 40 shifts to the sensorless control while gradually increasing the rotational speed.

The motor control unit 40 also measures an elapsed time Toff (=T6−T5) from a normal stop (time T5) to a restart (time T6) of the AC motor 5. In the case where the elapsed time Toff is a predetermined time Tx (10 seconds for example) or more, the motor control unit 40 performs the low acceleration control for starting the AC motor 5. This is for the reason that a remaining load (a pressure difference between a discharge pressure and an intake pressure of the scroll compressor 9) decreases with time in the period from the stop to the restart of the AC motor 5. Namely, in the case where the motor is stopped for a longer time, the remaining load decreases to a greater extent and therefore the load on the AC motor 5 at the time of the restart is small. Therefore, the possibility of a failure to start is low even under the low acceleration control. Accordingly, in the case where a predetermined time or more has elapsed since the stop of the motor, the motor control unit 40 performs the low acceleration control in order to reduce noise at the time of the start.

The motor control unit 40 performs the acceleration control for rotating the rotor with a low acceleration, until the rotational speed of the rotor reaches the rotational speed Nc₀. When the rotational speed reaches the rotational speed Nc₀ (time T7), the motor control unit 40 shifts to the sensorless control while gradually increasing the rotational speed.

In the case where the elapsed time Toff (=T9−T8) from a normal stop (time T8) to a restart (time T9) of the AC motor 5 is less than the predetermined time Tx, the motor control unit 40 starts the AC motor 5 by the high acceleration control. Thus, in the case where the time for which the motor is stopped is short, the load on the AC motor 5 at the time of the restart is still high. In this case, if the motor is started by the low acceleration control, there is a high possibility of a failure to start. In view of this, the motor control unit 40 performs the high acceleration control in the case where a predetermined time or more has not elapsed since the stop of the motor.

As seen from the foregoing, the motor control unit 40 measures the elapsed time from a stop to a start of the AC motor 5 in order to control the switching circuit 30 depending on a load on the scroll compressor 9. Subsequently, the motor control unit 40 calculates, based on the measured elapsed time, a target acceleration (a low acceleration or a high acceleration in this case) for starting the AC motor 5. Then, the motor control unit 40 controls the switching circuit 30 so that the rotor is started with the target acceleration.

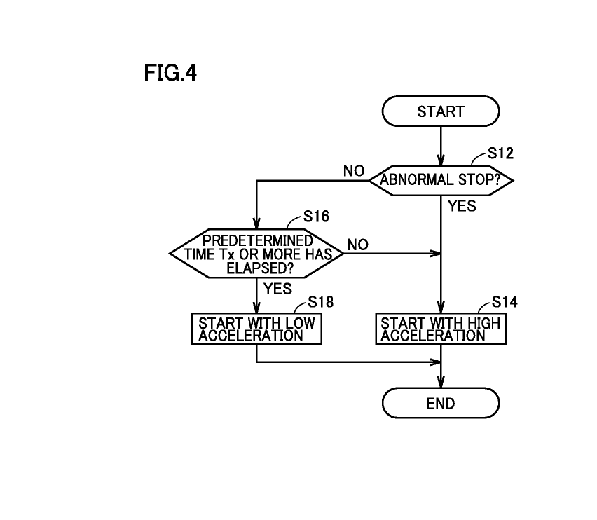

FIG. 4 is a flowchart showing a restart process performed by the motor control unit 40. It is supposed that the motor control unit 40 is driving the AC motor 5 by the sensorless control or performing initial driving of the AC motor 5.

Referring to FIG. 4, when the AC motor 5 which is being driven by the sensorless control or subjected to initial driving makes a stop, the motor control unit 40 determines whether the stop is an abnormal stop or not (namely an abnormal stop or a normal stop) (step S12). In the case where the motor control unit 40 determines that the stop is an abnormal stop (YES in step S12), the motor control unit 40 restarts the AC motor 5 by the high acceleration control (step S14) and ends the process.

In contrast, in the case where the motor control unit 40 determines that the stop is not an abnormal stop (the stop is a normal stop) (NO in step S12), the motor control unit 40 measures the time elapsed from the normal stop and determines whether the measured elapsed time is the predetermined time Tx or more (step S16).

In the case where the measured elapsed time is the predetermined time Tx or more (YES in step S16), the motor control unit 40 restarts the AC motor 5 by the low acceleration control (step S18) and ends the process. In contrast, in the case where the measured elapsed time is not the predetermined time Tx or more (NO in step S16), the motor control unit 40 restarts the AC motor by the high acceleration control (step S14) and ends the process.

As seen from the above-described flowchart, in the case where the AC motor 5 makes a stop based on a stop command (normal stop control) (in the case of NO in step S12), the motor control unit 40 in the present embodiment measures an elapsed time from the stop to a start of the AC motor 5, calculates a target acceleration of the rotor followed when the AC motor 5 is started, based on the measured elapsed time, and controls the switching circuit 30 so that the rotor is started with the target acceleration.

In the case where the AC motor 5 is restarted after stopped without a stop command (restart control) (in the case of YES in step S12), the motor control unit 40 controls the switching circuit 30 so that the rotor is started with a predetermined acceleration (high acceleration) regardless of the elapsed time.

In other words, in the case where the AC motor 5 is started after an abnormal stop of the AC motor 5, the motor control unit 40 controls the switching circuit 30 so that the rotor is accelerated with an acceleration (high acceleration) larger than an acceleration (low acceleration) of the rotor that is used in the case where the AC motor 5 is started after a normal stop of the AC motor 5 and the elapsed time from the normal stop to the start of the AC motor 5 is the predetermined time Tx or more.

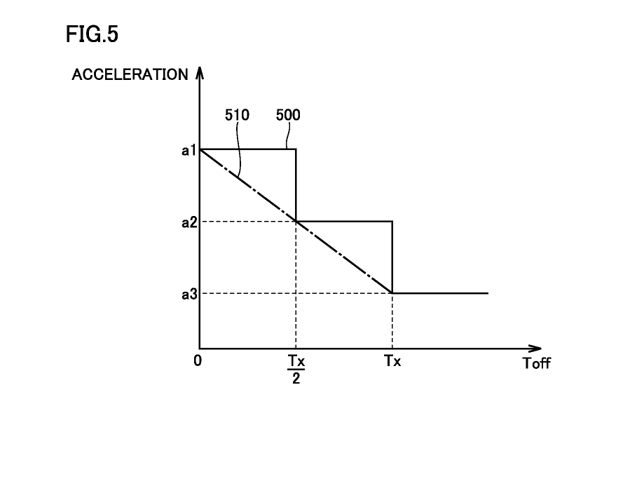

In the present embodiment described above, in the case where the AC motor 5 is started after a normal stop of the AC motor 5, the acceleration control is performed using one of the two accelerations, namely a low acceleration and a high acceleration, depending on the elapsed time Toff from the normal stop to the start. The embodiment, however, is not limited to this. For example, as shown in FIG. 5, the motor control unit 40 may calculate, based on the elapsed time Toff, the acceleration of the rotor in the case where the AC motor 5 is started after its normal stop, and control the switching circuit 30 so that the rotor is accelerated with the calculated acceleration.

FIG. 5 is a diagram showing a relationship between an acceleration when the motor is started and a time elapsed from a normal stop to a restart.

Referring to FIG. 5, in the case where the motor control unit 40 performs an acceleration control following a graph 500, the motor control unit 40 restarts the AC motor 5 by a high acceleration control (high acceleration a1) when 0≦Toff<Tx/2 is met, restarts the AC motor 5 by a middle acceleration control (middle acceleration a2) when Tx/2≦Toff<Tx is met, and restarts the AC motor 5 by a low acceleration control (low acceleration a3) when Tx≦Toff is met. Although the above description of the example in FIG. 5 is of the case where the acceleration is changed in three steps, the acceleration may also be changed in four or more steps.

Regarding a graph 510, the acceleration decreases in proportion to the length of the elapsed time Toff. Namely, in the case where the motor control unit 40 performs the acceleration control following the graph 510, the motor control unit 40 restarts the AC motor 5 with an acceleration which is smaller as the elapsed time Toff is longer.

### Effects of the Embodiment

According to the present embodiment, in the case where the motor having made an abnormal stop is restarted, the motor is started by the high acceleration control in order to prevent a failure of the start. In the case where the motor has made a normal stop, the high acceleration control or the low acceleration control is performed depending on the time elapsed from the stop to a restart of the motor. In this way, the motor can appropriately be restarted depending on the condition of the compressing unit from the stop to the restart of the motor.

In the case where the elapsed time is long enough to eliminate the pressure difference, there is a low possibility of a failure to start even when the high acceleration control is not performed, and therefore, the low acceleration control is performed. Accordingly, the sound that the motor makes when started can be reduced without sacrificing the startability.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An electric compressor comprising:
an AC motor including a rotor having a permanent magnet and a stator where a multi-phase coil is wound, and configured to drive a compressing unit; and
an inverter apparatus configured to control the AC motor,
the inverter apparatus including:
a switching circuit configured to supply the AC motor with current; and
a control unit configured to control the switching circuit, the control unit being configured to:
measure an elapsed time from a stop of the AC motor to a start of the AC motor for controlling the switching circuit depending on a load on the compressing unit;
calculate a target acceleration of the rotor followed when starting the AC motor, based on the measured elapsed time; and
control the switching circuit so that the rotor is started with the target acceleration.

2. The electric compressor according to claim 1, wherein
the longer the elapsed time, the smaller the target acceleration of the rotor.

3. The electric compressor according to claim 2, wherein
the control unit is configured to perform a normal stop control for stopping the AC motor based on a stop command and a restart control for restarting the AC motor after the AC motor is stopped without the stop command, and
the restart control includes controlling the switching circuit so that the rotor is started with a predetermined acceleration regardless of the elapsed time.
